(19) United States
(12) Patent Application Publication
(10) Pub. No.: US 2007/0195471 A1
(43) Pub. Date: Aug. 23, 2007

(54) Voltage clamp

(75) Inventors: Juan C. Fernandez, Riverview, FL (US); Brian West, Tampa, FL (US); Jeffrey D. Lewis, Seffner, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/356,483

(22) Filed: Feb. 17, 2006

(51) Int. Cl. H02H 9/00

(52) U.S. Cl. 361/56

(57) ABSTRACT

A voltage clamp is provided. The voltage clamp comprises one or more diodes for clamping a voltage in a circuit, and at least one capacitor coupled in parallel across the one or more diodes for maintaining current to the one or more diodes at levels which do not cause the clamping voltage of the one or more diodes to exceed a peak tolerable voltage.

### GOVERNMENT INTEREST STATEMENT

The U.S. Government may have certain rights in the present invention as provided for by the terms of a government contract.

### BACKGROUND

Voltage clamps are commonly used to limit voltage in a circuit to a maximum voltage. One example of a voltage clamp is a clamp using zener diodes which are reverse biased in a circuit to clamp a reverse voltage. The clamping voltage, i.e. the maximum reverse voltage, is therefore determined by the combined zener voltages of the zener diodes used in the voltage clamp. The zener voltage itself is dependent on the level of current in the voltage clamp. Due to this dependency, spikes in the current can cause the zener diodes to clamp to a higher voltage than desired. This can occur during power cycles when a circuit power is switched on and off. During the transition period of switching on and off the power, a current spike can occur, for example, in a rectifier circuit. The current spike essentially looks like a reverse voltage on the zener diodes. If the current spikes cause the zener diodes to clamp to a voltage value higher than the intended clamping voltage, error and noise can be inserted into a signal in the circuit.

Therefore, for the reasons stated above, and for other reasons stated below which will become apparent to those skilled in the art upon reading and understanding the present specification, there is a need in the art for an improved voltage clamp which ameliorates the problem of a voltage clamp clamping to a higher voltage value than intended.

### SUMMARY

The above-mentioned problems and other problems are resolved by the present invention and will be understood by reading and studying the following specification.

In one embodiment, a voltage clamp is provided. The voltage clamp comprises one or more diodes for clamping a voltage in a circuit, and at least one capacitor coupled in parallel across the one or more diodes for maintaining current to the one or more diodes at levels which do not cause the clamping voltage of the one or more diodes to exceed a peak tolerable voltage.

In another embodiment, a switching mode power converter is provided. The switching mode power converter comprises a transformer for transferring electrical energy, a rectifier circuit coupled to the transformer for converting an alternating current to a direct current, and a voltage clamp coupled to the rectifier circuit for limiting voltage to the rectifier circuit to a peak tolerable voltage. The voltage clamp comprises one or more diodes for clamping voltage to the rectifier circuit, and at least one capacitor coupled to the one or more diodes, the at least one capacitor being adapted to absorb excess charge during current spikes such that current to the one or more diodes is maintained at levels which do not cause the clamping voltage of the one or more diodes to exceed a peak tolerable voltage.

In another embodiment, a voltage clamp is provided. The voltage clamp comprises one or more zener diodes for clamping a voltage in a circuit, and a capacitor coupled in parallel with the one or more zener diodes for maintaining current to the one or more zener diodes at levels which do not cause the combined clamping voltage of the one or more zener diodes to exceed a peak tolerable voltage, wherein the capacitor working voltage is rated higher than the combined clamping voltage of the one or more zener diodes and the equivalent series resistance of the capacitor is sufficiently small relative to the impedance of the one or more zener diodes such that a current divider is not created between the one or more zener diodes and the capacitor.

In another embodiment, a method of assembling a circuit with a voltage clamp is provided. The method comprises coupling one or more diodes to a circuit, wherein the diodes are adapted to limit voltage in the circuit to a peak tolerable voltage, and coupling at least one capacitor across the one or more diodes, the at least one capacitor being adapted to maintain current to the one or more diodes at levels which do not cause the clamping voltage of the one or more diodes to exceed a peak tolerable voltage.

### DRAWINGS

FIG. 1 is a simplified block diagram of a switching mode power converter according to one embodiment of the present invention.

FIG. 2 is a circuit diagram of a voltage clamp according to one embodiment of the present invention.

FIG. 3 is a circuit diagram of a switching mode power converter according to one embodiment of the present invention.

FIG. 4 is a flow chart showing a method of assembling a circuit with a voltage clamp according to one embodiment of the present invention.

Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. It should also be understood that the exemplary methods illustrated may include additional or fewer steps or may be performed in the context of a larger processing scheme. Furthermore, the methods presented in the drawing figures or the specification are not to be construed as limiting the order in which the individual steps may be performed. The following detailed description is, therefore, not to be taken in a limiting sense.

Embodiments of the present invention enable a voltage clamp to clamp to a correct peak voltage despite the presence of current spikes which could otherwise affect the clamping voltage (also referred to herein as the breakdown voltage) of diodes in the voltage clamp. This is accomplished by controlling current levels such that current to the diodes during current spikes is maintained at levels that do not cause the clamping voltage of the diodes to exceed a peak tolerable voltage.

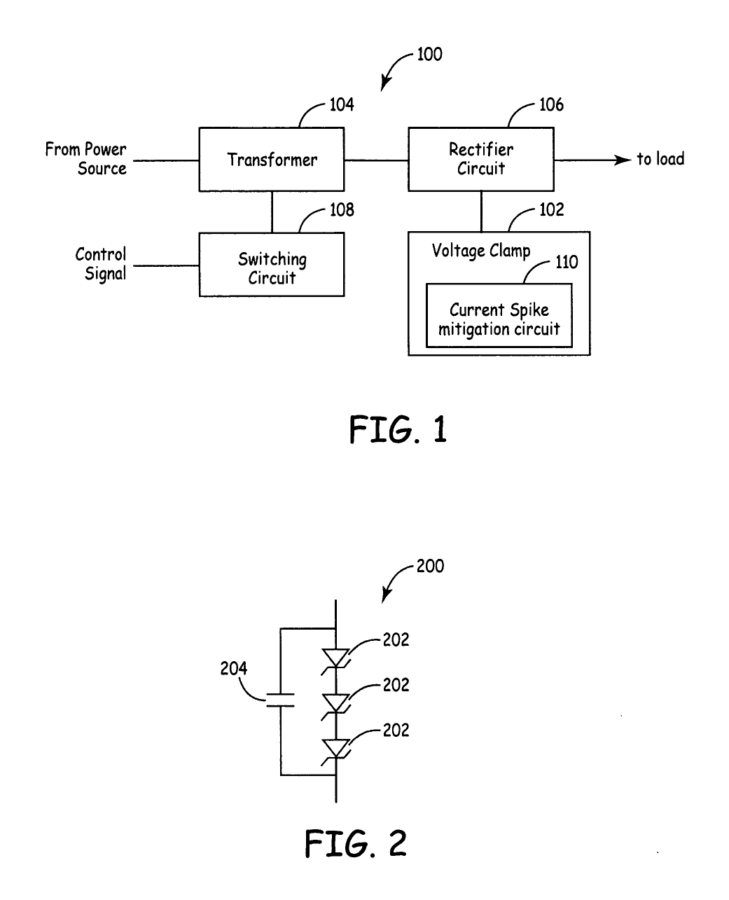

FIG. 1 is a simplified block diagram of a switching mode power converter 100 according to one embodiment of the present invention. Power converter 100 includes voltage clamp 102, transformer 104, rectifier circuit 106, and switching circuit 108. In some embodiments, power converter 100 is a flyback converter. In other embodiments, power converter 100 is implemented as other types of switching mode power converters. Transformer 104 transfers electrical energy as known to one of skill in the art. Similarly rectifier circuit 106 converts alternating current to direct current as known to one of skill in the art. Switching circuit 108 is used to switch current to the load (and consequently to rectifier circuit 106) on and off rapidly so that output voltage is stabilized. The load connected to a power supply via switching mode power converter 100 is any type of electrical device such as TV sets, computers, cell phones, etc. During the transition periods between switching on and off the current to rectifier circuit 106, current spikes which look like reverse voltages to rectifier circuit 106 can occur. Voltage clamp 102 is adapted to limit the peak reverse voltage to rectifier circuit 106 such that the reverse voltage to rectifier circuit 106 does not exceed the maximum amount of voltage that components of rectifier circuit 106 can tolerate. In addition, current spike mitigation circuit 110 of voltage clamp 102 is adapted to absorb excess current during current spikes to prevent voltage clamp 102 from clamping to an excessive peak reverse voltage (e.g. a voltage which exceeds a peak tolerable voltage) as a result of a current spike.

In operation, energy from a power supply is received at transformer 104. Also, a control signal is received by switch 108 which controls turning on and off switch 108. When switch 108 is turned on, energy is loaded into transformer 104. When a control signal turns switch 108 off, energy will be released from transformer 104 to a load through rectifier circuit 106. Rectifier circuit converts an alternating current (AC) input to a direct current (DC) output. Voltage clamp 102 clamps reverse voltages in rectifier circuit 106 to a peak voltage level that components of rectifier circuit 106 can tolerate. Additionally, current spike mitigation circuit 110 absorbs excess current in a current spike such that voltage clamp does not clamp to an excessive peak voltage.

FIG. 2 is a circuit diagram of a voltage clamp 200 according to one embodiment of the present invention. Voltage clamp 200 includes one or more diodes 202 and at least one capacitor 204. Diodes 202 are reverse biased. In some embodiments, diodes 202 are zener diodes. In other embodiments, diodes 202 are avalanche diodes. Additionally, in some embodiments, 3 diodes 202 are used. In other embodiments, N number of diodes are used. The number of diodes is chosen based on the desired clamping voltage. For example, if the desired clamping voltage is 32 volts, any appropriate combination of diodes, each having an individual diode voltage, which results in a clamping voltage of 32 volts can be used (e.g. two 10V diodes and one 12V diode).

Voltage clamp 200 mitigates against adverse affects of current spikes. Voltage clamp 200 uses capacitor 204 to mitigate against current spikes. Capacitor 204 is coupled in parallel across the one or more diodes 202. Although only one capacitor 204 is shown in FIG. 2, it will be understood by one of skill in the art that, in other embodiments, M number of capacitors 204 are used. Capacitor 204 is adapted to absorb excess charge to maintain current to diodes 202 at levels that do not cause the combined clamping voltage of diodes 202 to exceed a peak tolerable voltage. Capacitor 204 releases the stored charge slowly over time. In some embodiments, capacitor 204 is adapted to store and release current such that a substantially constant current to diodes 202 of voltage clamp 200 is maintained. By maintaining the current at levels that do not cause the combined clamping voltage of diodes 202 to exceed a peak tolerable voltage, voltage clamp 200 is able to clamp to the correct voltage despite current spikes. Capacitor 204 comprises any suitable type of capacitor, such as capacitors using bulk insulators and electrolytic capacitors. In embodiments using bulk insulators, the insulators include, but are not limited to, air-gap, ceramic, glass, paper, silvered MICA, polycarbonate, and any other suitable insulating material. In embodiments using electrolytic capacitors, capacitor 204 is made of any suitable material, such as aluminum and tantalum.

In some embodiments, capacitor 204 does not discharge too quickly between power cycles. For example, in some embodiments, capacitor 204 discharges less than approximately 5% of stored charge between power cycles. The amount of allowed discharge for a given application is dependent on how much voltage increase the application can withstand. For example, if voltage clamp 200 nominally holds 20V with average current and the given application requires that the clamp voltage not exceed 21V, then capacitor 204 needs to change less than 1V during a period of current surge (also referred to herein as a current spike). Assuming that the amount of discharge during a surge event can be neglected (e.g. the surge time is small relative to the period of the surges or the surge current is large relative to the average current), the minimum capacitor size (i.e. minimum capacitance) of capacitor 204 can be expressed as

$$C min = \frac{( Isurge * Tsurge )}{Vchange}$$

The term Isurge is surge current, Tsurge is the length of time of the surge, and Vchange is the allowed amount of change in the clamping voltage. Hence, for any given application, the minimum capacitance of capacitor 204 can be determined based on the current surge, length of the surge and maximum allowed capacitor voltage change (the current surge and length of the surge are determined empirically, in some embodiments). Additionally, in some embodiments, the maximum working voltage of capacitor 204 is rated higher than the maximum clamping voltage.

Capacitor 204 is also selected, in some embodiments, so that the effective series resistance (ESR) of capacitor 204 is small relative to the impedance of diodes 202. The ESR of capacitor 204 is considered small relative to the impedance of diodes 202 if a current divider is not created between capacitor 204 and diodes 202. For practical purposes, if the product of ESR max*Isurge in the equation

$$C min = \frac{( Isurge * Tsurge )}{( Vchange - ( ESR max * Isurge ) )}$$

is sufficiently small to be neglected, then the ESR of capacitor 204 is typically considered small relative to the impedance of diodes 202 in embodiments of the present invention.

In operation, diodes 202 are reverse-biased, thus preventing current flow from cathode to anode. Once the voltage drop exceeds the diode breakdown voltage, diodes 202 permit sufficient current to flow in the reverse direction to keep the voltage drop across each of diodes 202 at the breakdown voltage for each of diodes 202. Hence, voltage across diodes 202 is clamped to the sum of voltage drops across diodes 202. Capacitor 204 absorbs excess current during current spikes to prevent current spikes from causing the combined clamping voltage of diodes 202 to exceed a peak tolerable voltage.

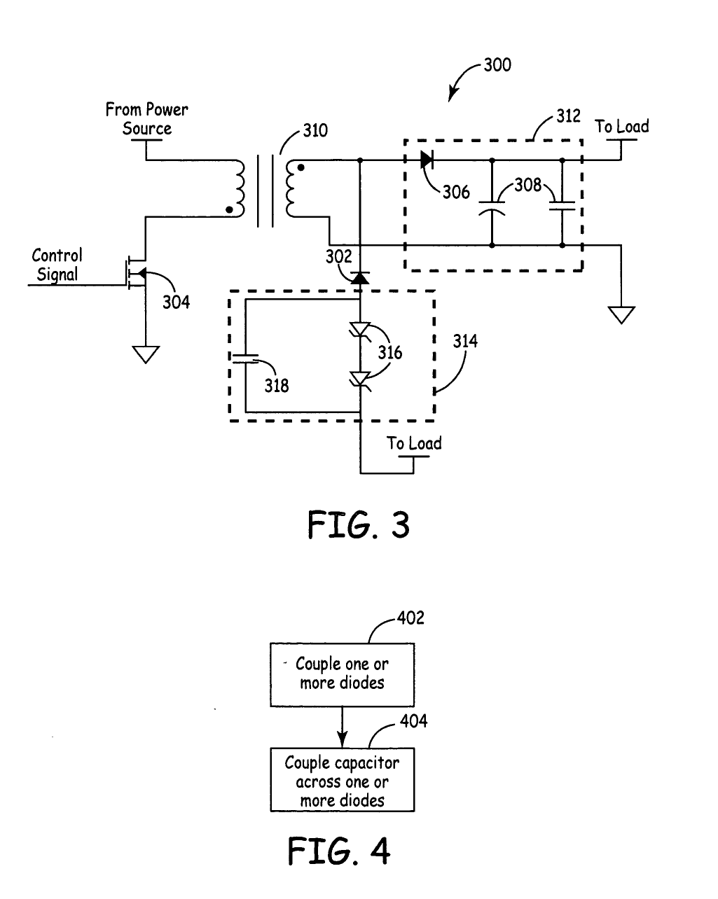

FIG. 3 is a circuit diagram of a switching mode power converter 300 according to one embodiment of the present invention. In some embodiments, power converter 300 is a flyback converter as shown in FIG. 3. However, it will be understood by one of skill in the art that in other embodiments, other types switching mode power converters are used. Power converter 300, includes transformer 310, switching diode 302, rectifier circuit 312, and insulated-gate field-effect transistor (IGFET) 304. In some embodiments, IGFET 304 is implemented as a metal oxide semi-conductor field-effect transistor (MOSFET). In other embodiments, IGFET 304 is implemented as a field-effect transistor whose gate insulator is not an oxide. In yet other embodiments, one of an insulated gate bipolar transistor (IGBT) and a bipolar junction transistor (BJT) is used in place of IGFET 304. Also, in some embodiments, rectifier circuit 312 includes, as shown in FIG. 3, diode 306 for rectifying a signal and capacitors 308 for smoothing the rectified signal. Function of the above mentioned components are known to one of skill in the art and not discussed further herein.

Converter 300 also includes voltage clamp 314. Voltage clamp 314 includes one or more diodes 316 and at least one capacitor 318, as described above In some embodiments, diodes 316 are zener diodes. In other embodiments, diodes 316 are avalanche diodes. Voltage clamp 314 is coupled to in parallel to rectifier circuit 312 in order to clamp the peak reverse voltage felt by rectifier circuit 312. As described above, capacitor 318 absorbs excess charge during current spikes in order to prevent diodes 316 from clamping to an excessive peak voltage as a result of the increased current during the current spike.

In operation, energy from a power supply is received at transformer 310 and a control signal is received by IGFET 304. In some embodiments, the control signal is a pulse-width modulated control signal. In other embodiments, other modulation schemes are used for the control signal. The control signal turns IGFET 304 on and off. When IGFET 304 is turned on, transformer 310 stores energy received from the power source. When IGFET 304 is turned off, transformer 310 releases energy to a load through rectifier circuit 312. Rectifier circuit 312 converts an AC input to a DC output. When IGFET 304 is again turned off, rectifier circuit 312 stops conducting and transformer 310 again stores energy. Diodes 316 of voltage clamp 314 is coupled in parallel with rectifier circuit 312 such that reverse voltages felt by rectifier circuit 312 during transition periods of turning on and off IGFET 304 do not exceed a peak voltage which diode 306 of rectifier circuit 312 can tolerate. Capacitor 318 is coupled in parallel across diodes 316 to absorb current from current spikes during the transition periods in order to maintain current to diodes 316 at levels which do not cause the clamping voltage (e.g. zener voltage and avalanche voltage) of diodes 316 to exceed the peak tolerable voltage of diode 306 in rectifier circuit 312. In this way, diodes 316 do not clamp to an excessive voltage despite current spikes.

FIG. 4 is a flow chart showing a method 400 of assembling a circuit with a voltage clamp according to one embodiment of the present invention. At 402, one or more diodes are coupled to a circuit. The one or more diodes are reverse biased to limit a reverse voltage to a peak tolerable voltage (e.g. clamping voltage). In some embodiments, one or more zener diodes are coupled to the circuit. In other embodiments, one or more avalanche diodes are coupled to the circuit. Additionally, in some embodiments, 3 diodes are used. In other embodiments, N number of diodes are used. The diodes clamp a reverse voltage to the diode breakdown voltage.

At 404, a capacitor is coupled in parallel across the one or more diodes. In some embodiments, a capacitor is selected which has a maximum working voltage that is rated higher than the combined breakdown voltages (i.e. the clamping voltage) of the one or more diodes, as discussed above. Also, in some embodiments, a capacitor is selected which does not discharge too rapidly between power cycles of the converter, as discussed above. A capacitor is also selected, in some embodiments, such that the ESR of the capacitor is small relative to the impedance of the one or more diodes, as discussed above. The capacitor absorbs excess charge during current spikes enabling the one or more diodes to clamp to a voltage which does not exceed a peak tolerable voltage despite the current spike.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A voltage clamp, comprising;
one or more diodes for clamping a voltage in a circuit; and
at least one capacitor coupled in parallel across the one or more diodes for maintaining current to the one or more diodes at levels which do not cause the clamping voltage of the one or more diodes to exceed a peak tolerable voltage.

2. The voltage clamp of claim 1, wherein the one or more diodes comprise one of zener diodes and avalanche diodes.

3. The voltage clamp of claim 1, wherein the one or more diodes comprises 3 diodes.

4. The voltage clamp of claim 1, wherein the at least one capacitor is adapted to discharge less than approximately 5% of stored charge between power cycles.

5. The voltage clamp of claim 1, wherein the at least one capacitor has a maximum working voltage that is rated higher than the combined clamping voltage of the one or more diodes.

6. The voltage clamp of claim 1, wherein the equivalent series resistance of the at least one capacitor is sufficiently small relative to the impedance of the one or more diodes such that a current divider is not created between the one or more diodes and the at least one capacitor.

7. A switching mode power converter, comprising:
a transformer for transferring electrical energy;
a rectifier circuit coupled to the transformer for converting an alternating current to a direct current; and
a voltage clamp coupled to the rectifier circuit for limiting voltage to the rectifier circuit to a peak tolerable voltage, the voltage clamp comprising:
one or more diodes for clamping voltage to the rectifier circuit; and
at least one capacitor coupled to the one or more diodes, the at least one capacitor being adapted to absorb excess charge during current spikes such that current to the one or more diodes is maintained at levels which do not cause the clamping voltage of the one or more diodes to exceed a peak tolerable voltage.

8. The switching mode power converter of claim 7, wherein the at least one capacitor is adapted to discharge less than approximately 5% of stored charge between power cycles of the converter.

9. The switching mode power converter of claim 7, wherein the working voltage of the at least one capacitor is rated higher than the clamping voltage of the voltage clamp.

10. The switching mode power converter of claim 7, wherein the one or more diodes comprise one of zener diodes and avalanche diodes.

11. The switching mode power converter of claim 7, wherein the one or more diodes comprise 3 diodes.

12. The switching mode power converter of claim 7, wherein the equivalent series resistance of the at least one capacitor is sufficiently small relative to the impedance of the one or more diodes such that a current divider is not created between the one or more diodes and the at least one capacitor.

13. A voltage clamp comprising:
one or more zener diodes for clamping a voltage in a circuit; and
a capacitor coupled in parallel with the one or more zener diodes for maintaining current to the one or more zener diodes at levels which do not cause the combined clamping voltage of the one or more zener diodes to exceed a peak tolerable voltage, wherein the capacitor working voltage is rated higher than the combined clamping voltage of the one or more zener diodes, and the equivalent series resistance of the capacitor is sufficiently small relative to the impedance of the one or more zener diodes such that a current divider is not created between the one or more zener diodes and the capacitor.

14. The voltage clamp of claim 13, wherein the one or more zener diodes comprise 3 zener diodes.

15. The voltage clamp of claim 13, wherein the capacitor is further adapted to discharge less than approximately 5% of stored charge between power cycles.

16. A method of assembling a circuit with a voltage clamp, the method comprising:
coupling one or more diodes to a circuit, wherein the diodes are adapted to limit voltage in the circuit to a peak tolerable voltage; and
coupling at least one capacitor across the one or more diodes, the at least one capacitor being adapted to maintain current to the one or more diodes at levels which do not cause the clamping voltage of the one or more diodes to exceed a peak tolerable voltage.

17. The method of assembling a circuit with a voltage clamp of claim 16, wherein coupling at least one capacitor comprises coupling at least one capacitor whose working voltage is rated higher than the combined clamping voltage of the one or more diodes.

18. The method of assembling a circuit with a voltage clamp of claim 16, wherein coupling one or more diodes comprises coupling one of zener diodes and avalanche diodes.

19. The method of assembling a circuit with a voltage clamp of claim 16, wherein coupling one or more diodes comprises coupling 3 diodes to a circuit.
